(19) United States
(12) Patent Application Publication
(10) Pub. No.: US 2016/0170254 A1
(43) Pub. Date: Jun. 16, 2016

(54) LIQUID CRYSTAL DISPLAY AND MANUFACTURING METHOD THEREOF

(71) Applicant: Samsung Display Co., Ltd., Yongin-City (KR)

(72) Inventors: Seung-Yeon CHAE, Hwaseong-si (KR); Sang Gun CHOI, Suwon-si (KR); Han Su KIM, Seoul (KR); Tae Woon CHA, Seoul (KR)

(21) Appl. No.: 14/795,493

(22) Filed: Jul. 9, 2015

(30) Foreign Application Priority Data
Dec. 11, 2014 (KR) 10-2014-0178257

(51) Int. Cl. G02F 1/1339; G02F 1/1335; G02F 1/1333; G02F 1/1368

(52) U.S. Cl. CPC G02F 1/13394; G02F 1/1368; G02F 1/133512; G02F 1/133377; G02F 1/133345

(57) ABSTRACT

A liquid crystal display (LCD) according to an exemplary embodiment includes: a substrate including a display area and a peripheral area; a thin film transistor disposed on the substrate; a field generating electrode connected to the thin film transistor; a partition wall disposed along the peripheral area; a roof layer facing the field generating electrode; a roof pattern covering the partition wall; and a liquid crystal layer disposed between the field generating electrode and the roof layer and formed as a plurality of microcavities including liquid crystal molecules. The roof layer and the roof pattern are formed of at least one inorganic layer.

### CROSS-REFERENCE TO RELATED APPLICATION

This application claims priority to and the benefit of Korean Patent Application No. 10-2014-0178257 filed in the Korean Intellectual Property Office on Dec. 11, 2014, the entire contents of which are incorporated herein by reference.

### BACKGROUND

(a) Field

The present application relates to a liquid crystal display (LCD) and a manufacturing method thereof.

(b) Description of the Related Art

As one of the most widely used flat panel displays at present, a liquid crystal display (LCD) includes two display panels on which field generating electrodes such as a pixel electrode and a common electrode are formed, and a liquid crystal layer interposed between the two display panels.

The LCD displays an image by generating an electric field on a liquid crystal layer by applying a voltage to the field generating electrodes, determining alignment directions of liquid crystal molecules of the liquid crystal layer by the generated field, and controlling polarization of incident light.

For one type of LCD, a technique of forming a plurality of microcavities in pixels and filling liquid crystals therein has been developed to implement a display.

Two sheets of substrates are used for conventional LCDs, but components can be formed on one substrate to reduce weight and thickness of a display device.

In order to arrange and align liquid crystal molecules, a manufacturing method of such a display device includes a process of injecting and then drying an aligning agent prior to injecting liquid crystals, also called liquid crystal molecules.

In this case, the aligning agent may overflow to an edge portion of the panel, thereby causing contact failure of a pad portion.

The above information disclosed in this Background section is only for enhancement of understanding of the background and therefore it may contain information that does not form the prior art that is already known in this country to a person of ordinary skill in the art.

### SUMMARY

Embodiments have been made in an effort to prevent defects of a pad portion due to overflow of an aligning agent and to provide a liquid crystal display (LCD) for protecting an outer light blocking layer, and a manufacturing method thereof.

An LCD according to an exemplary embodiment includes: a substrate including a display area and a peripheral area; a thin film transistor disposed on the substrate; a field generating electrode connected to the thin film transistor; a partition wall disposed along the peripheral area; a roof layer facing the field generating electrode; a roof pattern covering the partition wall; and a liquid crystal layer disposed between the field generating electrode and the roof layer and formed as a plurality of microcavities including liquid crystal molecules. The roof layer and the roof pattern are formed of at least one inorganic layer.

The LCD may further include a light blocking layer disposed on the substrate. The light blocking layer may be disposed in the peripheral area, and the partition wall may be formed on the light blocking layer.

The LCD may further include a common electrode disposed between the plurality of microcavities and the roof layer, and a common electrode pattern disposed between the partition wall and the roof pattern.

The partition wall may be formed of an organic material or a photoresist.

Multiple partition walls may be formed.

The roof layer and the roof pattern may be separated.

The roof layer may include a structure in which first and second inorganic layers having different stresses are laminated.

The first inorganic layer may have a compressive stress, and the second inorganic layer may have a tensile stress.

The first and second inorganic layers may be alternately laminated.

A manufacturing method of an LCD according to an exemplary embodiment includes: forming a thin film transistor on a substrate including a display area and a peripheral area; forming a pixel electrode connected to the thin film transistor; forming a sacrificial layer in the display area and the peripheral area; forming a roof layer on the sacrificial layer; forming a plurality of microcavities with inlets by removing the sacrificial layer; and injecting liquid crystal molecules into the plurality of microcavities. The roof layer is formed of at least one inorganic layer, and the sacrificial layer formed in the peripheral area is not removed to thereby form a partition wall.

The manufacturing method of an LCD may further comprise forming a roof pattern on the partition wall. The roof pattern and the roof layer may be formed of the same material.

The manufacturing method of an LCD may further comprise forming a light blocking layer in the peripheral area. The light blocking layer may be formed to be disposed under the partition wall.

The forming of the roof layer may include forming an inorganic layer on the sacrificial layer and forming a liquid crystal injection portion by patterning the inorganic layer, and the roof layer and the roof pattern may be separated in the patterning of the inorganic layer.

The manufacturing method of an LCD may further comprise forming a common electrode and a common electrode pattern on the sacrificial layer before the forming of the roof layer. The common electrode pattern may be disposed between the light blocking layer and the roof pattern.

The forming of the roof layer may include sequentially laminating first and second inorganic layers having different stresses.

An LCD according to an exemplary embodiment includes: a substrate including a display area and a peripheral area; a thin film transistor disposed on the substrate; a field generating electrode connected to the thin film transistor; a roof layer facing the field generating electrode; a partition wall disposed along the peripheral area; and a liquid crystal layer disposed between the field generating electrode and the roof layer and formed as a plurality of microcavities including liquid crystal molecules. The roof layer and the partition wall include a color filter.

The LCD may further comprise a light blocking layer disposed on the substrate. The light blocking layer may be disposed in the peripheral area, and the partition wall may be disposed on the light blocking layer.

The LCD may further include: a lower insulating layer and a common electrode that are disposed between the plurality of microcavities and the roof layer; an upper insulating layer disposed on the roof layer; a lower insulating pattern and a common electrode pattern that are disposed under the partition wall; and an upper insulating pattern disposed on the partition wall.

Multiple partition walls may be formed.

The roof layer and the partition wall may be separated.

According to the exemplary embodiment, the partition wall having a dam structure is formed at its outer edge portion, thereby preventing defects of the pad portion due to overflow of the aligning material.

According to the exemplary embodiment, the patterns covering the outer light blocking layer can be formed to prevent the light blocking layer from being torn off.

### BRIEF DESCRIPTION OF THE DRAWINGS

FIG. 1 is a top plan view of a liquid crystal display (LCD) according to an exemplary embodiment.

FIG. 2 is a partial top plan view of some of a plurality of pixels illustrated in FIG. 1.

FIG. 3 is a cross-sectional view of FIG. 2 taken along the line III-Ill.

FIG. 4 is a cross-sectional view of FIG. 2 taken along the line IV-IV.

FIG. 5 is a cross-sectional view of FIG. 1 taken along the line V-V.

FIG. 6 is a cross-sectional view of an LCD modified from the exemplary embodiment of FIG. 5.

FIG. 7 is a cross-sectional view of an LCD modified from the exemplary embodiment of FIG. 3.

FIGS. 8, 9, 10, 11, 12, 13, 14, 15, 16, 17, 18, 19, 20, and 21 are cross-sectional views illustrating a manufacturing method of an LCD according to an exemplary embodiment.

FIGS. 22, 23, 24, 25, and 26 are cross-sectional views of an LCD according to an exemplary embodiment.

FIG. 27 is a cross-sectional view of an LCD modified from the exemplary embodiment of FIG. 26.

### DETAILED DESCRIPTION OF THE EMBODIMENTS

The inventive concept will be described more fully hereinafter with reference to the accompanying drawings, in which exemplary embodiments are shown.

As those skilled in the art would realize, the described embodiments may be modified in various different ways, all without departing from the spirit or scope of the inventive concept.

On the contrary, exemplary embodiments introduced herein are provided to make disclosed contents thorough and complete and to sufficiently transfer the spirit of the inventive concept to those skilled in the art.

In the drawings, the thickness of layers and regions may be exaggerated for clarity.

In addition, when a layer is described to be formed on another layer or substrate, this means that the layer may be formed directly on the other layer or substrate, or a third layer may be interposed between the layer and the other layer or the substrate.

Like reference numerals designate like elements throughout the specification.

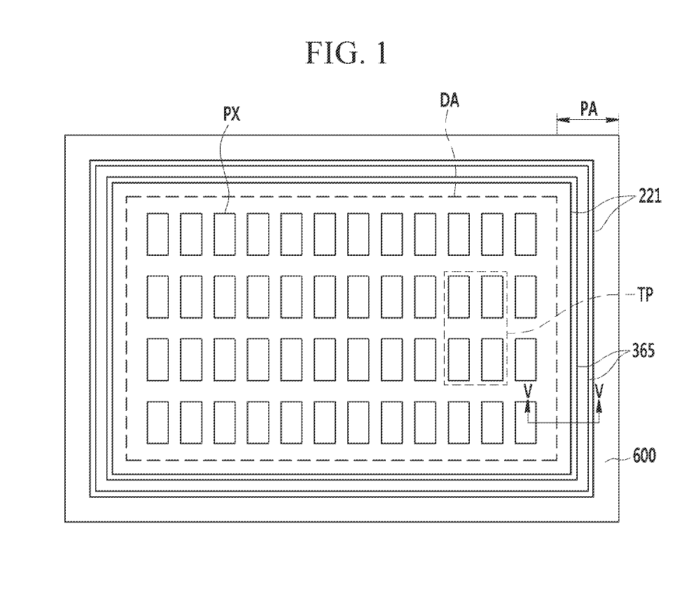

FIG. 1 is a top plan view of a liquid crystal display (LCD) according to an exemplary embodiment.

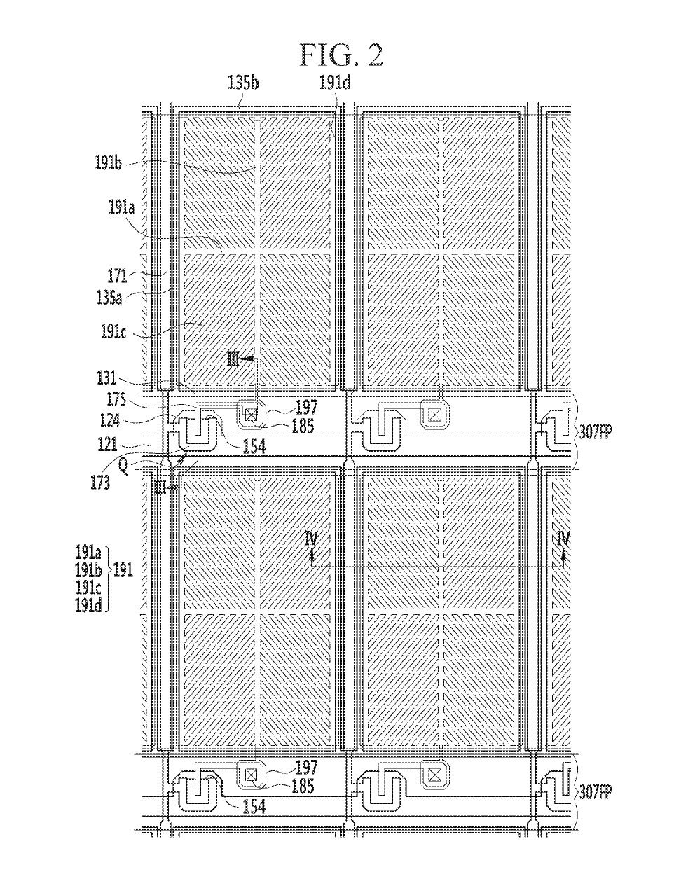

FIG. 2 is a partial top plan view of some of a plurality of pixels illustrated in FIG. 1.

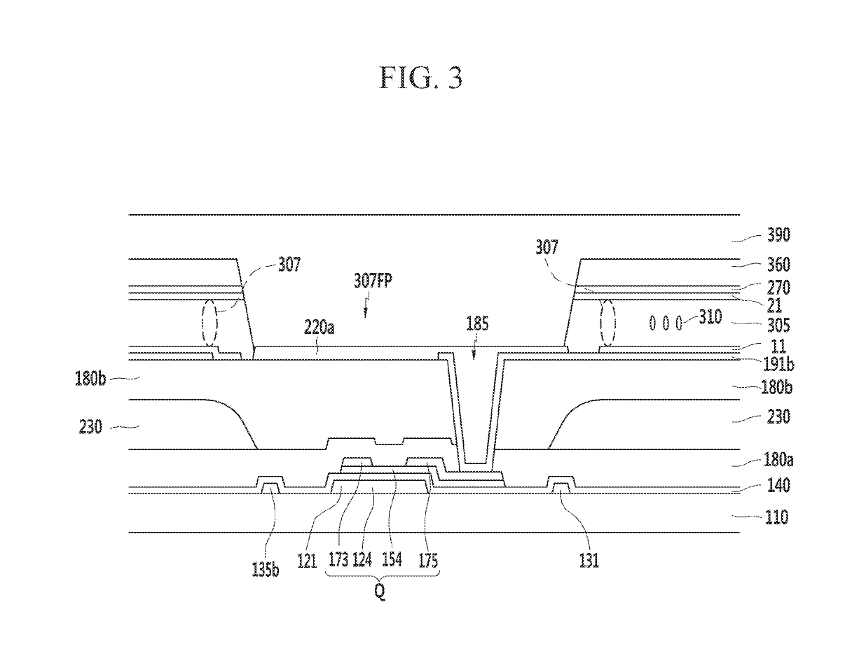

FIG. 3 is a cross-sectional view of FIG. 2 taken along the line III-III.

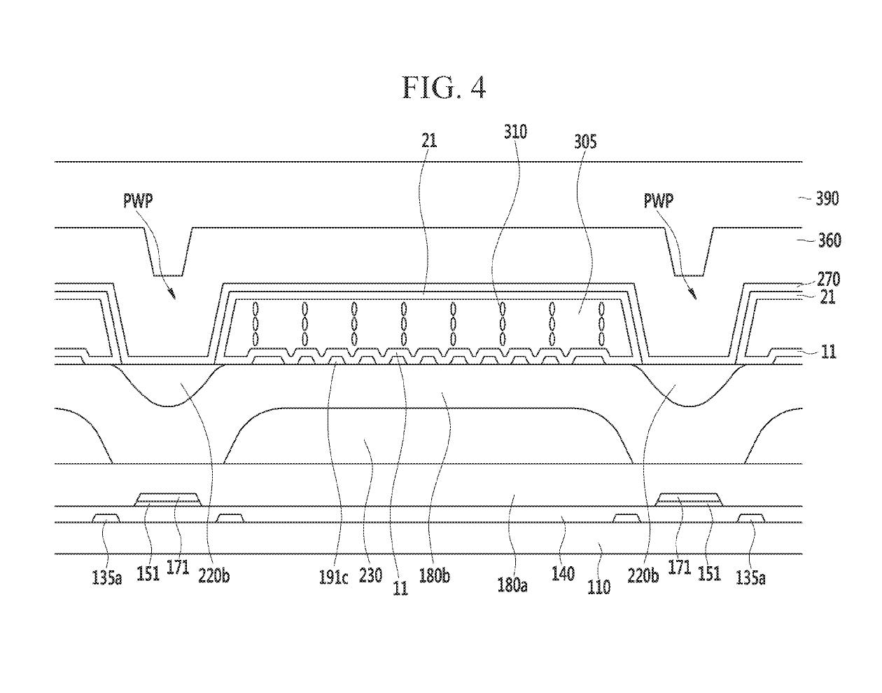

FIG. 4 is a cross-sectional view of FIG. 2 taken along the line IV-IV.

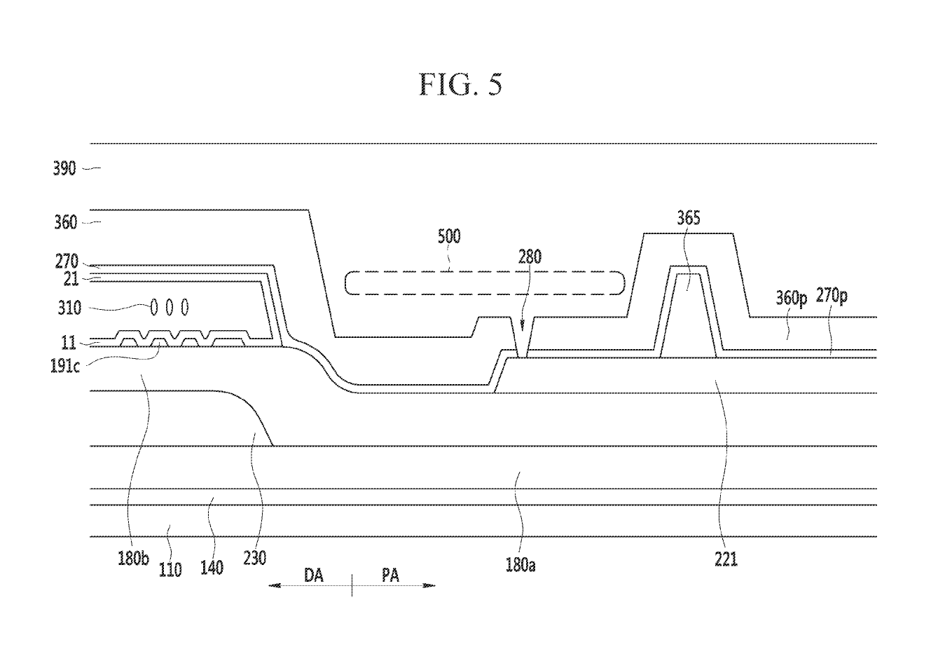

FIG. 5 is a cross-sectional view of FIG. 1 taken along the line V-V.

Referring first to FIG. 1, the LCD according to the current exemplary embodiment includes a display area DA and a peripheral area PA. As illustrated in FIG. 1, the display area DA represents an inner part of a quadrangle that is marked by a dotted line, and the peripheral area PA represents an outer part of the quadrangle that is marked by the dotted line.

The display area DA is where an image is actually outputted, and a pad portion 600 or a driving unit may be disposed in the peripheral area PA.

Actually, in the pad portion 600 of FIG. 1, a pad may be disposed at any side of the peripheral area PA or at two sides thereof that do not face each other.

A plurality of pixels PX are disposed in the display area DA, and a light blocking layer 221 is disposed in the peripheral area PA to cover portions in which light leakage can occur.

The light blocking layer 221 may be formed to surround the display area DA from outside of the display area DA.

The light blocking layer 221 may be formed of the same material and on the same layer as the light blocking member, e.g., the light blocking member (220a and 220b) as described below, that is disposed in the display area DA.

The light blocking layer 221 may serve to block external light from being reflected and recognized.

A partition wall 365 may be disposed to overlap the light blocking layer 221.

However, the partition wall 365 is not limited to the current exemplary embodiment, and unlike as shown in FIG. 1, it may be disposed along one side, two sides, or three sides of the peripheral area PA.

Referring to FIGS. 2 to 4, the pixel PX disposed in the display area DA will now be described in detail.

FIG. 2 illustrates a 2*2 pixel portion (TP) that is a part of the plurality of pixels, and in the LCD according to the exemplary embodiment, the 2*2 pixel portion may be repeatedly arranged in up/down and left/right directions.

Referring to FIGS. 2 to 4, a gate line 121 and a storage electrode line 131 are formed on a substrate 110 that is formed of transparent glass or plastic.

The gate line 121 includes a gate electrode 124.

The storage electrode line 131 substantially extends in a horizontal direction, and transmits a predetermined voltage such as a common voltage Vcom or the like.

The storage electrode line 131 includes a pair of horizontal portions 135a extending substantially perpendicular to the gate line 121, and a vertical portion 135b for interconnecting ends of the pair of horizontal portions 135a.

The storage electrodes 135a and 135b have a structure for surrounding a pixel electrode 191.

A gate insulating layer 140 is formed on the gate line 121 and the storage electrode line 131.

A semiconductor layer 151 disposed under a data line 171 and a semiconductor layer 154 disposed under source and drain electrodes 173, 175 and in a channel portion of a thin film transistor Q are formed on the gate insulating layer 140.

A plurality of ohmic contacts may be formed on each of the semiconductor layers 151 and 154 and between the data line 171 and the source/drain electrodes 173, 175, but they are omitted in the drawing.

Data conductors 171, 173, and 175 including a source electrode 173, the data line 171 connected to the source electrode 173, and a drain electrode 175 are formed on each of the semiconductor layers 151 and 154 and the gate insulating layer 140.

The gate electrode 124, the source electrode 173, and the drain electrode 175 form the thin film transistor Q along with the semiconductor layer 154, and a channel of the thin film transistor Q is formed in a portion of the semiconductor layer 154 between the source electrode 173 and the drain electrode 175.

A first interlayer insulating layer 180a is formed on exposed portions of the semiconductor layer 154 that are not covered with the data conductors 171, 173, and 175, the source electrode 173, and the drain electrode 175.

The first interlayer insulating layer 180a may include an inorganic material such as a silicon nitride (SiNₓ) or a silicon oxide (SiOₓ).

A color filter 230 is formed on the first interlayer insulating layer 180a.

Each color filter 230 may display one of three primary colors such as red, green, and blue.

The color filter 230 is not limited to displaying the three primary colors of red, green, and blue, and may display one of cyan, magenta, yellow, and white-based colors.

The color filter 230 may be formed of materials for displaying different colors for each of the adjacent pixels.

A second interlayer insulating layer 180b is formed on the color filter 230 and the first interlayer insulating layer 180a.

The second interlayer insulating layer 180b may reduce or eliminate steps because it is formed of an organic material.

A contact hole 185 is formed in the color filter 230 and the interlayer insulating layers 180a and 180b to expose the drain electrode 175.

Through the contact hole 185, the drain electrode 175 may be electrically and physically connected to the pixel electrode 191 that is disposed on the second interlayer insulating layer 180b.

The pixel electrode 191 will now be described in detail.

The pixel electrode 191 may be formed of a transparent conductive material such as ITO or IZO.

The pixel electrode 191 has an overall quadrangular shape, and includes a cross-shaped stem portion having a horizontal stem portion 191a and a vertical stem portion 191b perpendicular thereto.

In addition, the pixel electrode is divided into four subregions by the horizontal stem portion 191a and the vertical stem portion 191b, and each subregion includes a plurality of minute branch portions 191c.

In addition, in the current exemplary embodiment, an outer stem portion 191d may be further included to interconnect the minute branch portions 191c at left and right edges of the pixel electrode 191.

In the current exemplary embodiment, the outer stem portion 191d is disposed at the left and right edges of the pixel electrode 191, but it may be extended further to be disposed at upper and lower edges of the pixel electrode 191.

The minute branch portions 191c of the pixel electrode 191 form an angle of approximately 400 to 450 with the gate line 121 or the horizontal stem portion 191a.

The minute branch portions 191c of two adjacent subregions may be perpendicular to each other.

A width of the minute branch portions may become gradually wider, or gaps between the minute branch portions 191c may be different.

An extension 197 is connected to a lower end of the vertical stem portion 191b and has a larger area than the vertical stem portion 191b. The pixel electrode 191 is physically and electrically connected to the drain electrode 175 through the contact hole 185 by the extension 197 and is applied with a data voltage from the drain electrode 175.

Since the aforementioned description of the thin film transistor Q and the pixel electrode 191 is just an example, a structure of the thin film transistor and a design of the pixel electrode can be modified to improve side visibility.

For example, using different voltages generated in each region according to resistance distribution, an RD-TFT structure can be formed to improve the side visibility.

On the pixel electrode 191, a light blocking member (220a and 220b) is disposed to cover the data line 171 and the area where the thin film transistor Q is formed.

The light blocking member (220a and 220b) has a lattice structure including an opening corresponding to an area for displaying an image, and is formed of a material through which light cannot pass.

The color filter 230 may be disposed to correspond to the opening of the light blocking member (220a and 220b).

The light blocking member (220a and 220b) includes a horizontal light blocking member 220a formed along a direction parallel to the gate line 121, and a vertical light blocking member 220b formed along a direction parallel to the data line 171.

A lower alignment layer 11 is formed on the pixel electrode 191, and the lower alignment layer 11 may be a vertical alignment layer.

The lower alignment layer 11 may be formed to include at least one of materials such as polysiloxane, polyimide, and the like that are generally used as a liquid crystal alignment layer.

In addition, the lower alignment layer 11 may be a photoalignment layer.

An upper alignment layer 21 is disposed to face the lower alignment layer 11, and a plurality of microcavities 305 are formed between the lower and upper alignment layers 11 and 21.

A liquid crystal material including liquid crystal molecules 310 is injected into the microcavity 305, and the microcavity 305 has an inlet 307.

The microcavity 305 may be formed along a column direction of the pixel electrode 191, that is, a vertical direction.

In the current exemplary embodiment, an aligning material for forming the alignment layers 11 and 21 and the liquid crystal material including the liquid crystal molecules 310 may be injected into the microcavity 305 using capillary force.

In the current exemplary embodiment, the lower and upper alignment layers 11 and 21 are distinguished from each other only by their positions, and as shown in FIG. 4, may be connected to each other.

The lower and upper alignment layers 11 and 21 may be simultaneously formed.

The microcavity 305 is vertically divided by a plurality of liquid crystal injection portions 307FP that are disposed to overlap the gate line 121, thereby forming the plurality of microcavities 305.

In this case, the plurality of microcavities 305 may be formed along the column direction of the pixel electrode 191, that is, the vertical direction.

Further, the microcavity 305 is horizontally split by a partition wall portion (PWP) to be described later to form the plurality of microcavities 305, and the plurality of microcavities 305 may be formed along the row direction of the pixel electrode 191, that is, the horizontal direction toward which the gate line 121 extends.

Each of the microcavities 305 formed in a plural number may correspond to one or more pixel areas, and the pixel areas may correspond to the area where the image is displayed.

The liquid crystal injection portion 307FP may be an empty space from which a common electrode 270, a roof layer 360, and the like are removed.

After being injected with the alignment layers 11 and 21 and the liquid crystal material including the liquid crystal molecules 310, the liquid crystal injection portion 307FP may be covered with a capping layer 390 to be described later.

The liquid crystal injection portion 307FP may be filled with the aligning material or the liquid crystal material such that it can serve as a passageway through which the aligning material or the liquid crystal material is injected into the microcavity 305.

The common electrode 270 is disposed on the upper alignment layer 21.

The common electrode 270 is applied with the common voltage and generates an electric field along with the pixel electrode 191 to which the data voltage is applied, thereby determining tilt directions of the liquid crystal molecules 310 disposed in the microcavity 305 between the two electrodes 270, 191.

The common electrode 270 may be formed of a transparent conductive material such as ITO or IZO.

The common electrode 270 forms a capacitor along with the pixel electrode 191 to maintain an applied voltage even after the thin film transistor Q is turned off.

In the current exemplary embodiment, the common electrode 270 has been described to be formed on the microcavity 305, but in another exemplary embodiment, the common electrode 270 may be formed under the microcavity 305, thereby allowing liquid crystals to be driven according to a coplanar electrode (CE) mode.

In the current exemplary embodiment, the roof layer 360 is an inorganic insulating layer that is formed of an inorganic material such as a silicon nitride (SiNₓ) or a silicon oxide (SiOₓ).

The roof layer 360 serves as a structure for supporting the microcavity 305 such that the microcavity 305 formed between the pixel electrode 191 and the common electrode 270 can maintain its shape.

To serve as the structure of the microcavity 305, in the current exemplary embodiment, the roof layer 360 formed only of an inorganic layer may have a thickness of about 4000 Å or more, and more preferably, about 6000 Å to 12,000 Å.

According to the exemplary embodiment, unlike the related art, only the inorganic layer may be used to form the roof layer 360 without using the organic layer, thereby simplifying a process.

In the current exemplary embodiment, the roof layer 360 may be disposed on an entire surface of the substrate 110 except for the area where it is removed from the liquid crystal injection portion 307FP.

The capping layer 390 is disposed on the roof layer 360.

The capping layer 390 includes an organic material or an inorganic material.

In the current exemplary embodiment, the capping layer 390 may contact a top surface of the roof layer 360 that is formed only of an inorganic layer.

The capping layer 390 may be disposed not only on the roof layer 360 but also in the liquid crystal injection portion 307FP.

In this case, the capping layer 390 may cover the inlet 307 of the microcavity 305 that is exposed by the liquid crystal injection portion 307FP.

In the current exemplary embodiment, the liquid crystal material is illustrated to be removed from the liquid crystal injection portion 307FP, but after being injected into the microcavity 305, the remaining liquid crystal material may exist in the liquid crystal injection portion 307FP.

In the current exemplary embodiment, as shown in FIG. 4, the partition wall portion (PWP) is formed between the microcavities 305 that are adjacent in the horizontal direction.

The partition wall portion (PWP) serves to fill a space between the microcavities 305 that are adjacent to each other in the horizontal direction.

As shown in FIG. 4, the partition wall portion (PWP) is formed to completely fill the space between the microcavities 305, but it is not necessarily limited thereto, and may be modified to partially fill the space.

The partition wall portion (PWP) may be formed along the direction toward which the data line 171 extends.

In the current exemplary embodiment, since a partition wall structure such as the partition wall portion (PWP) exists between the microcavities 305, the insulation substrate 110 is exposed to less stress even if it is bent, and therefore a degree of a cell gap variation can be greatly reduced.

A structural characteristic of the peripheral area PA according to the exemplary embodiment will now be described with reference to FIGS. 1 and 5.

Referring to FIGS. 1 and 5, an edge portion 500 is formed in the peripheral area PA adjacent to the pixels PX that are disposed at an edge of the display area DA.

The edge portion 500 corresponds to a space between the outermost pixel PX of the display area DA and the light blocking layer 221 of the peripheral area PA.

In the current exemplary embodiment, the partition wall 365 is disposed on the light blocking layer 221 that is disposed in the peripheral area PA.

The partition wall 365 may be linearly formed along one side of the peripheral area PA.

The partition wall 365 is a structure that is formed to form the microcavity 305 and is then removed, that is, a structure in which the sacrificial layer remains in the peripheral area PA.

When being injected and then dried, the aligning agent is non-uniformly dried particularly at the edge portion of the display area DA since its drying characteristics vary depending on where it is located in the liquid crystal display panel. For example, the aligning agent is dried at the edge portion of the display area DA faster than at the center portion of the display area DA.

Accordingly, light leakage may occur due to the non-uniformly dried aligning agent.

To solve such a problem, the aligning agent may be oversupplied. Therefore, the aligning agent is diffused uniformly, so that light leakage may be prevented.

In this case, the aligning agent may be supplied to the edge portion 500 that is marked in FIG. 5.

The aligning agent oversupplied to the edge portion 500 may affect, e.g., may overflow into and contaminate, the pad portion 600 to deteriorate stability of a module.

Even if not being intentionally oversupplied, the aligning agent may overflow to supply it to the edge portion 500.

However, in the current exemplary embodiment, since the partition wall 365, e.g., having a dam structure, is formed between the pad portion 600 and the edge portion 500, stability of the pad portion 600 can be ensured even if the aligning agent is oversupplied or overflows.

In addition, remaining solids may be uniformly distributed after evaporation in the edge portion 500, such that the light leakage is prevented from being recognized in the edge portion 500.

A common electrode pattern 270p and a roof pattern 360p are disposed on the partition wall 365 of the peripheral area PA.

In this case, the common electrode 270 and the roof layer 360 of the display area DA are respectively extended to form the common electrode pattern 270p and the roof pattern 360p.

The common electrode pattern 270p and the common electrode 270 may be formed of the same material and on the same layer, and the roof pattern 360p and the roof layer 360 may be formed of the same material and on the same layer.

The capping layer 390 may cover the display area DA and the peripheral area PA.

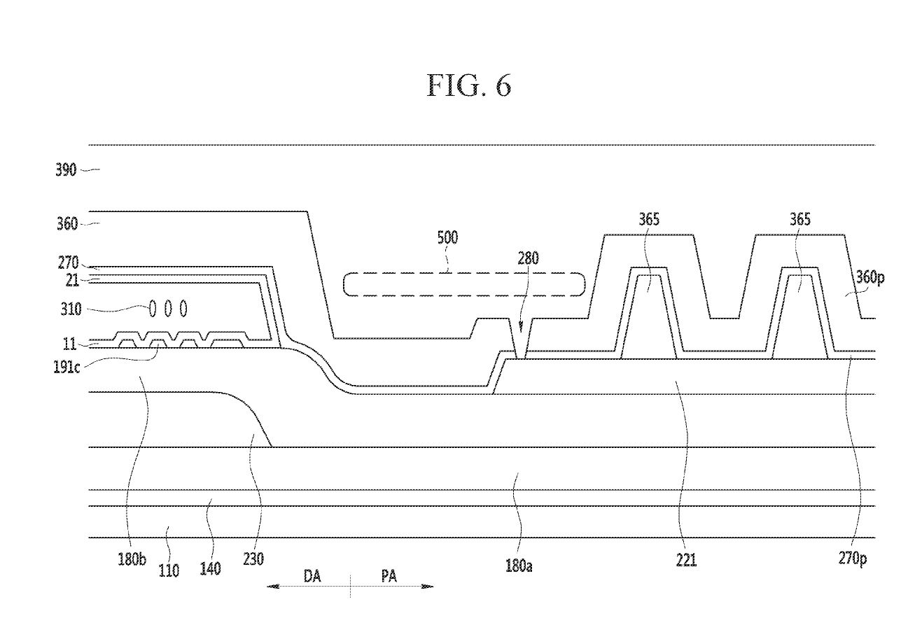

FIG. 6 is a cross-sectional view of an LCD modified from the exemplary embodiment of FIG. 5.

An exemplary embodiment to be described in FIG. 6 is substantially the same as the exemplary embodiment described with reference to FIG. 5 except for a structure of the partition wall.

Referring to FIG. 6, in the current exemplary embodiment, a plurality of partition walls 365 may be formed.

When the plurality of partition walls 365 are formed as described above, an effect of the oversupplied or overflowed aligning material for the pad portion 600 can be greatly reduced.

In addition to the aforementioned differences, the details described in FIG. 5 may be applied to the current exemplary embodiment.

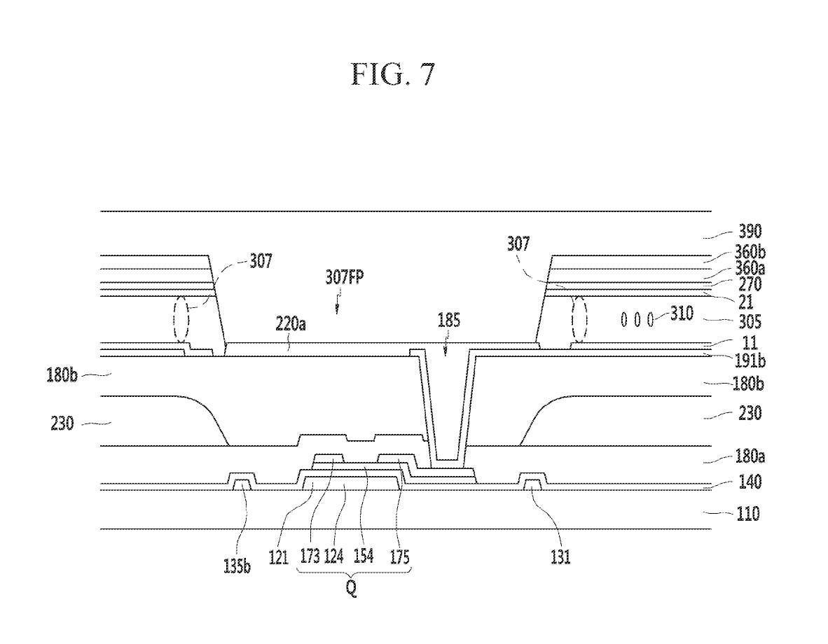

FIG. 7 is a cross-sectional view of an LCD modified from the exemplary embodiment of FIG. 3.

The exemplary embodiment to be described in FIG. 7 is substantially the same as the exemplary embodiment described with reference to FIG. 3 except for a structure of the roof layer 360.

Referring to FIG. 7, the roof layer 360 according to the exemplary embodiment may include a first inorganic layer 360a and a second inorganic layer 360b disposed on the first inorganic layer 360a.

The first inorganic layer 360a and the second inorganic layer 360b may have different stresses.

For example, the first inorganic layer 360a may have a compressive stress, while the second inorganic layer 360b may have a tensile stress.

Alternatively, the first inorganic layer 360a may have the tensile stress, while the second inorganic layer 360b may have the compressive stress.

As shown in the current exemplary embodiment, the inorganic layers having different stress characteristics may be laminated to form the roof layer 360, thereby allowing stress of the roof layer 360 to be controlled.

Accordingly, deformation of the roof layer 360 may be minimized.

In a further exemplary embodiment, the first inorganic layer 360a, the second inorganic layer 360b, and a third inorganic layer (not shown) may be sequentially laminated to form the roof layer 360.

In this case, the first inorganic layer 360a may have the compressive stress, the second inorganic layer 360b may have the tensile stress, and the third inorganic layer may have the compressive stress.

Alternatively, the first inorganic layer 360a may have the tensile stress, the second inorganic layer 360b may have the compressive stress, and the third inorganic layer may have the tensile stress. Each of the first inorganic layer 360a, the second inorganic layer 360b, the third inorganic layer may include an inorganic insulator such as a silicon nitride (SiNx) and a silicon oxide (SiOx).

In this case, the roof layer 360 has been illustrated to have a triple layer structure, but it is not limited thereto, and the inorganic layers having different stresses may be alternately laminated to form the roof layer 360.

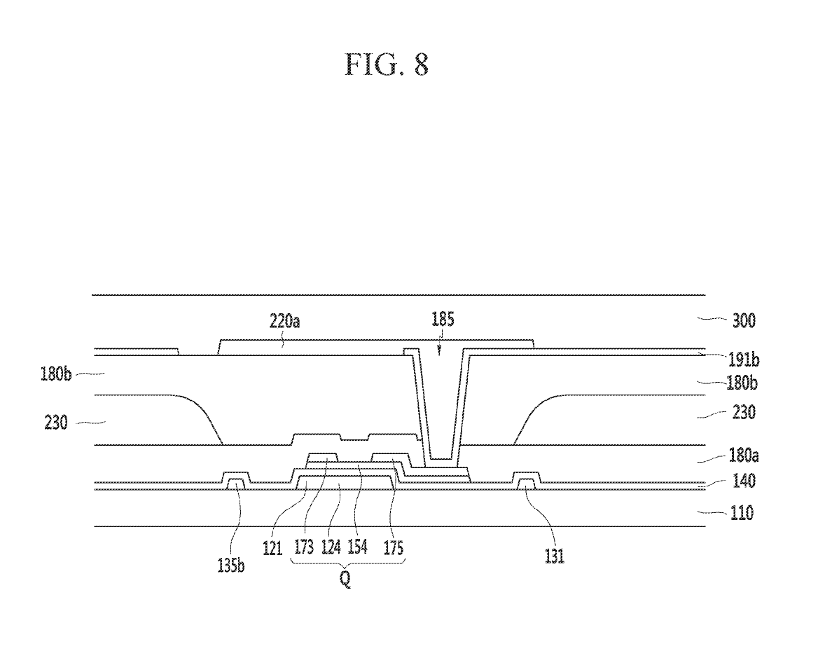

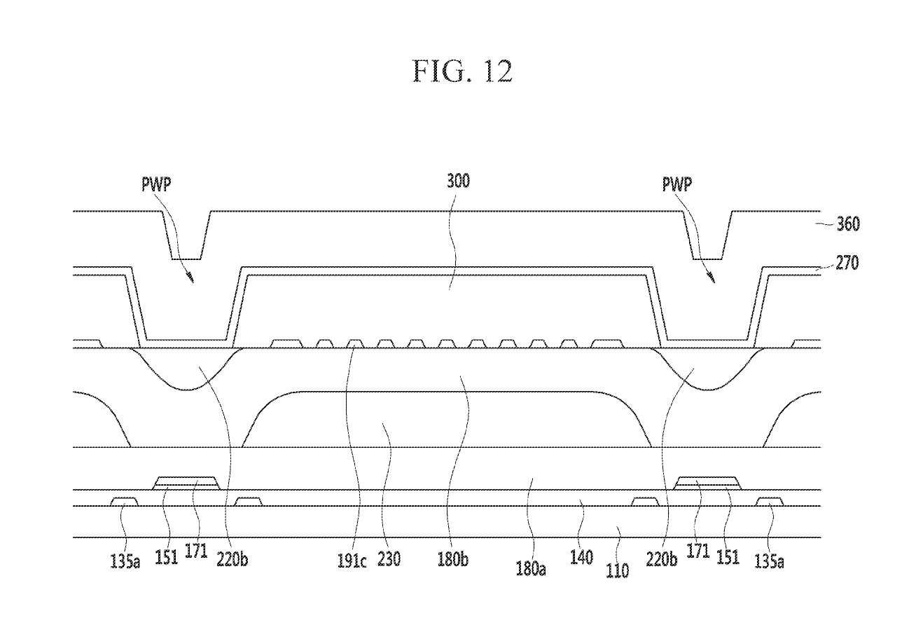

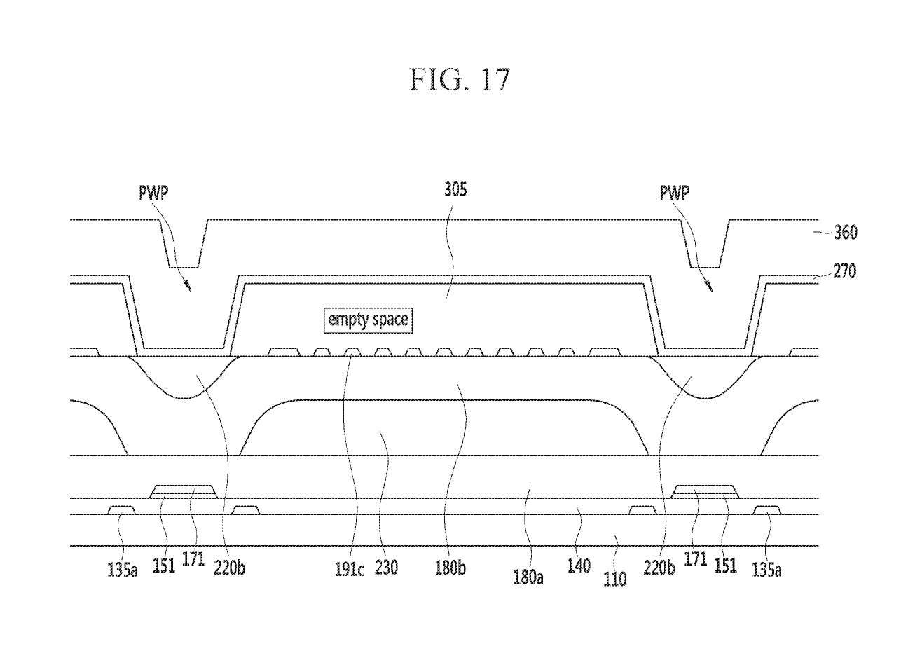

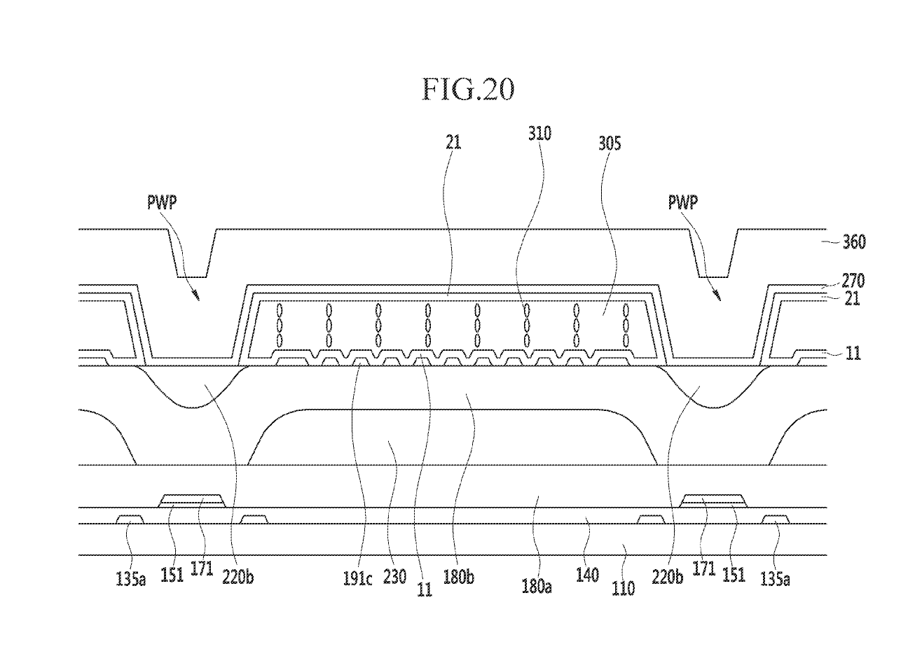

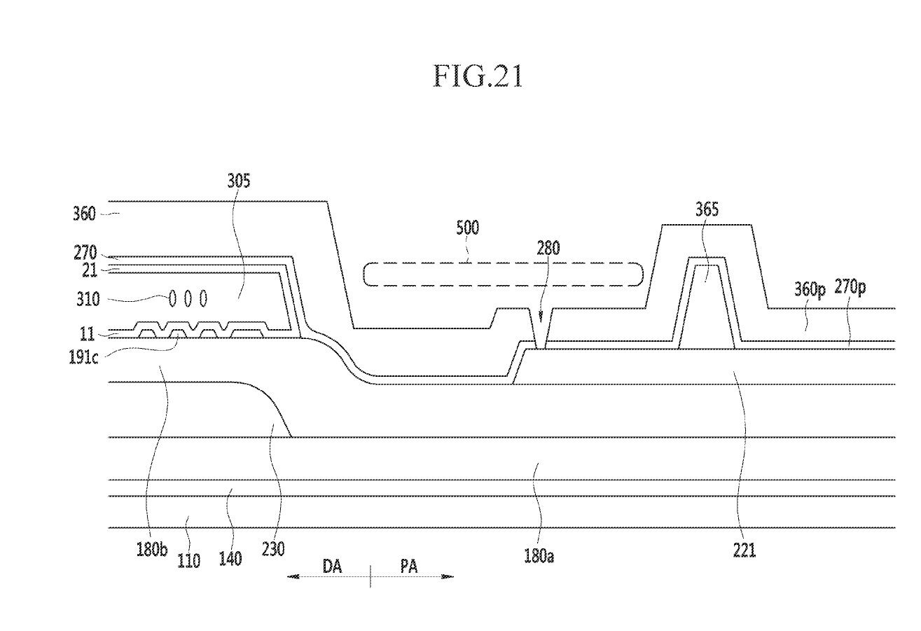

An exemplary embodiment of the aforementioned manufacturing method of the LCD will now be described with reference to FIGS. 8 to 21.

The exemplary embodiment to be described below is the exemplary embodiment of the manufacturing method, and it may be modified in different ways.

FIGS. 8 to 21 are cross-sectional views of a manufacturing method of an LCD according to an exemplary embodiment.

FIGS. 8, 11, 14, 16, and 19 are sequential cross-sectional views of FIG. 2 taken along the line III-III.

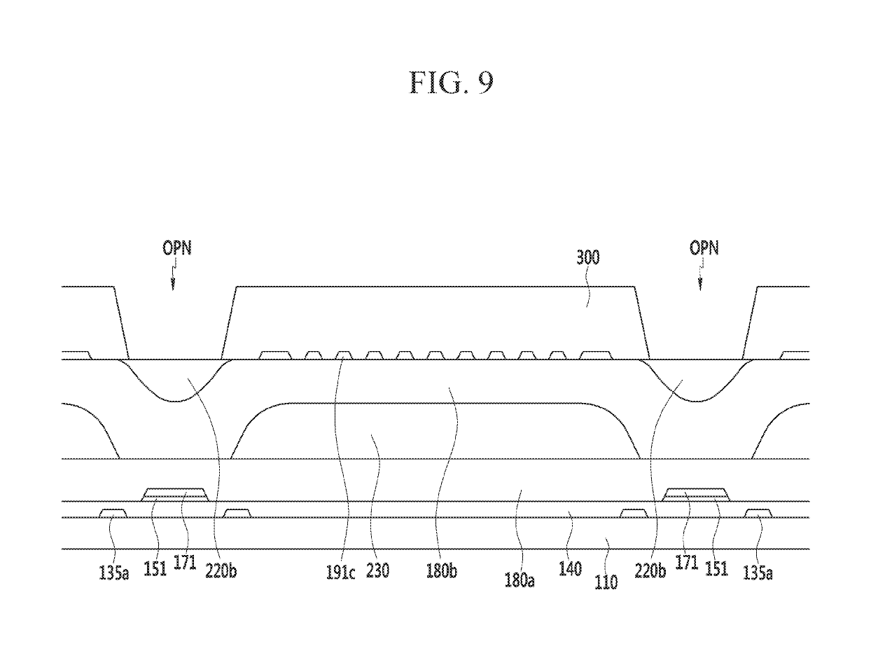

FIGS. 9, 12, 17, and 20 are sequential cross-sectional views of FIG. 2 taken along the line IV-IV.

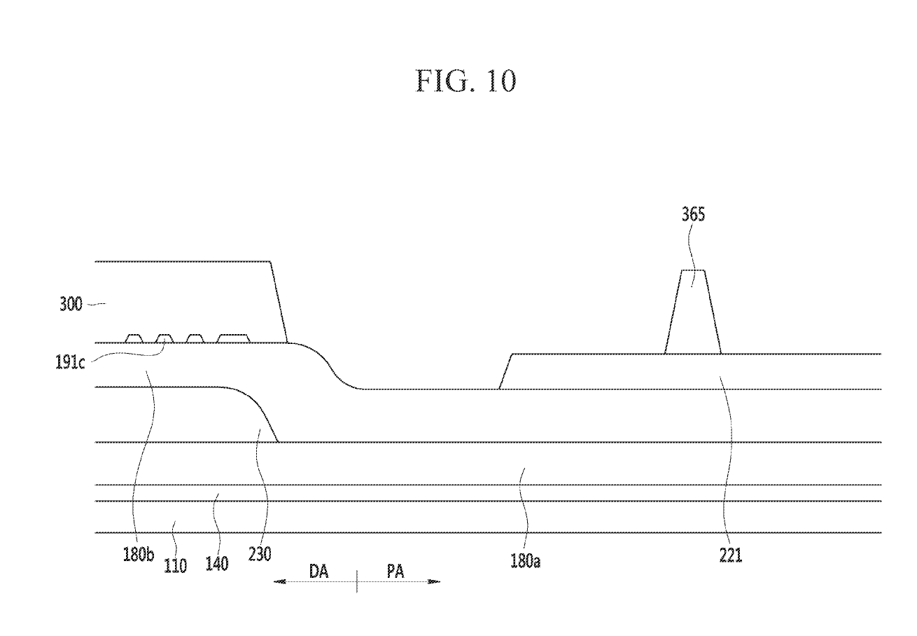

FIGS. 10, 13, 15, 18, and 21 are sequential cross-sectional views of FIG. 1 taken along the line V-V.

Referring to FIGS. 2, 8, and 9, in order to form a generally-known switching element Q on a substrate 110, a gate line 121 is formed to extend in a horizontal direction, a gate insulating layer 140 is formed on the gate line 121, semiconductor layers 151 and 154 are formed on the gate insulating layer 140, and a source electrode 173 and a drain electrode 175 are formed.

In this case, a data line 171 connected to the source electrode 173 may be formed to extend in a vertical direction while crossing the gate line 121.

A first interlayer insulating layer 180a is formed on the data conductors 171, 173, and 175 including the source electrode 173, the drain electrode 175, and the data line 171, and an exposed portion of the semiconductor layer 154.

A color filter 230 is formed at a position corresponding to a pixel area on the first interlayer insulating layer 180a.

A second interlayer insulating layer 180b is formed on the color filter 230 and the first interlayer insulating layer 180a.

A contact hole 185 is formed to penetrate the first and second interlayer insulating layers 180a and 180b.

A pixel electrode 191 is formed on the second interlayer insulating layer 180b such that the pixel electrode 191 and the drain electrode 175 are electrically and physically connected to each other through the contact hole 185.

A light blocking member (220a and 220b) is formed on the pixel electrode 191 and the second interlayer insulating layer 180b.

The light blocking member (220a and 220b) is formed to have a lattice structure including an opening corresponding to an area for displaying an image.

The light blocking member (220a and 220b) is formed of a material through which light cannot pass.

The light blocking member (220a and 220b) may be formed to include a horizontal light blocking member 220a formed along a direction parallel to the gate line 121, and a vertical light blocking member 220b formed along a direction parallel to the data line 171.

Referring to FIGS. 1 and 10, when the light blocking member (220a and 220b) is formed, a light blocking layer 221 disposed in the peripheral area PA may be integrally formed.

Next, a sacrificial layer 300 is formed on the pixel electrode 191 and the light blocking member 220.

As shown in FIG. 9, an open portion (OPN) is formed in the sacrificial layer 300 along the direction parallel to the data line 171.

In a subsequent process, a common electrode 270 and a roof layer 360 may be filled in the open portion (OPN) to form a partition wall portion (PWP).

When the sacrificial layer 300 according to the current exemplary embodiment is formed, a partition wall 365 may be formed on the light blocking layer 221 of the peripheral area PA.

The partition wall 365 may be formed of the same material as the sacrificial layer 300.

The sacrificial layer 300 may be formed of a photoresist material or an organic material.

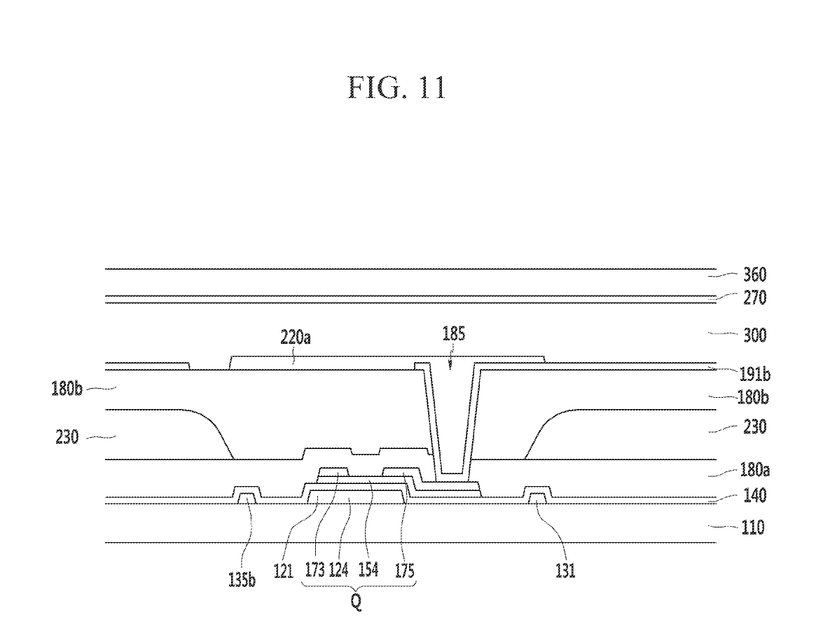

Referring to FIGS. 11 to 13, the common electrode 270 and the roof layer 360 are sequentially formed on the sacrificial layer 300.

The roof layer 360 may be an inorganic layer.

In this case, the common electrode 270 and the roof layer 360 not only fill the open portion (OPN) of the sacrificial layer 300, but also form the partition wall portion (PWP).

In the current exemplary embodiment, the roof layer 360 is illustrated as a single inorganic layer, but in a modified exemplary embodiment, it may have a structure in which a plurality of inorganic layers having different stresses are laminated.

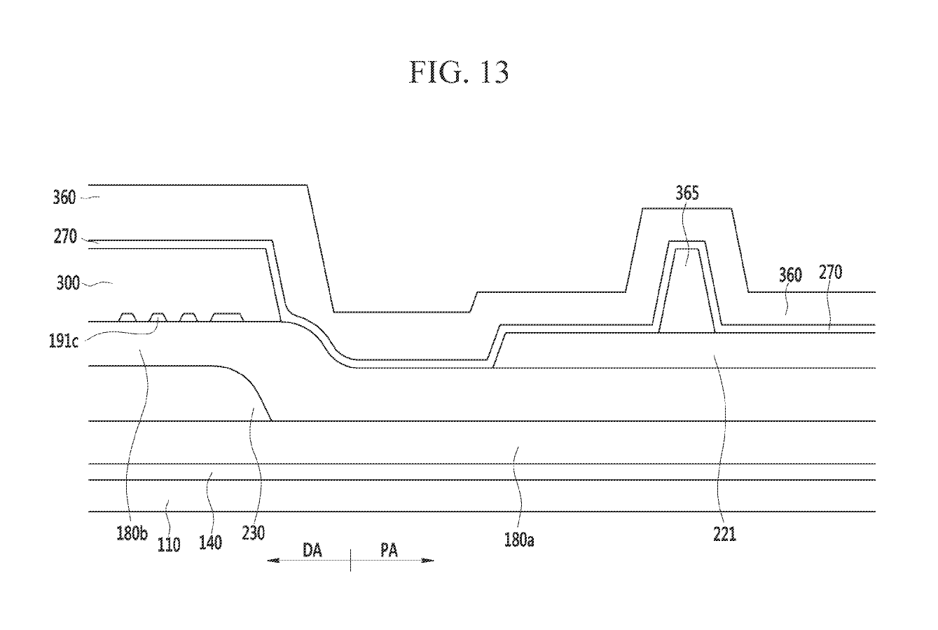

As shown in FIG. 13, the common electrode 270 and the roof layer 360 may be extended further to the peripheral area PA to cover the partition wall 365.

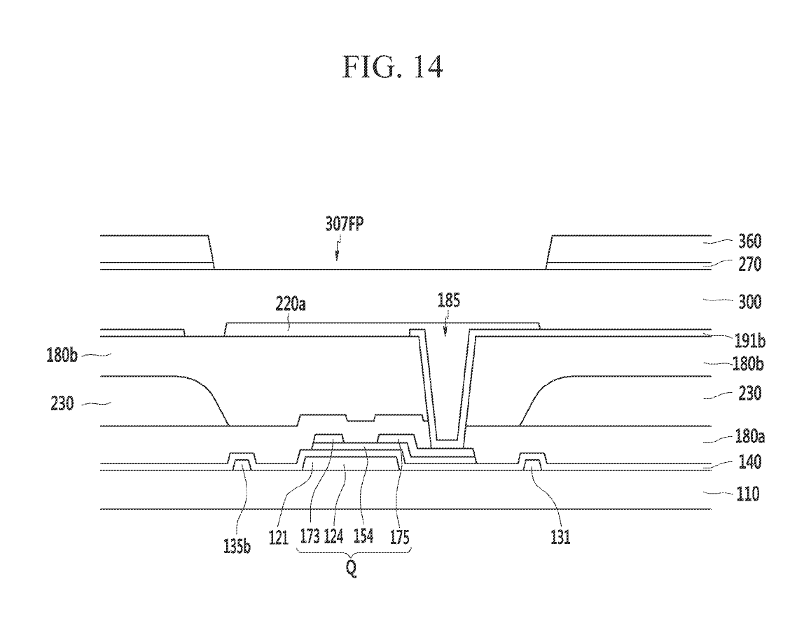

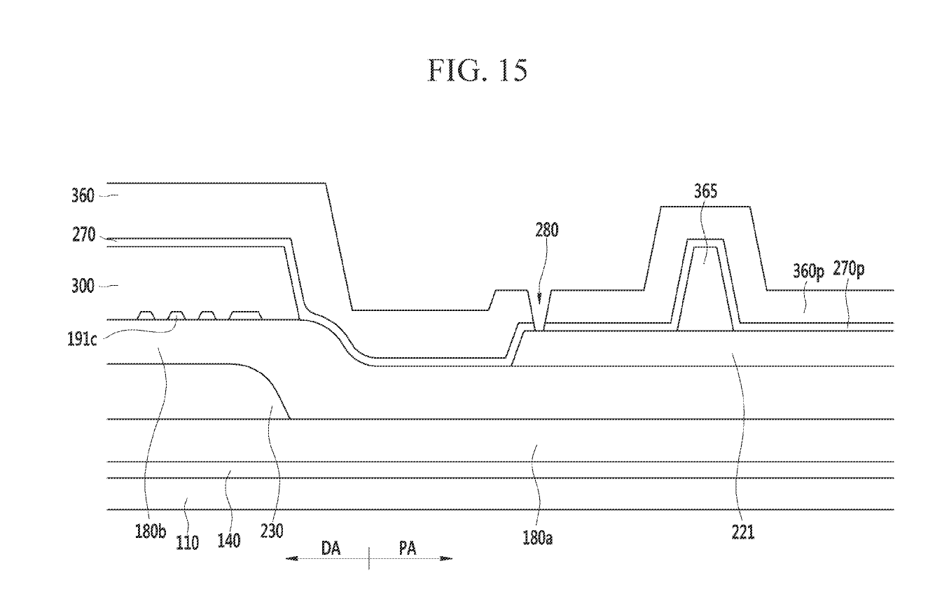

Referring to FIGS. 14 and 15, the roof layer 360 and the common electrode 270 may be patterned using the same mask.

A dry etching method may be used to etch the roof layer 360 and the common electrode 270.

The roof layer 360 and the common electrode 270 may be partially removed to expose the sacrificial layer 300 as well as to form a liquid crystal injection portion 307FP.

In this case, as shown in FIG. 15, a separating portion 280 is formed to separate the common electrode 270 and the roof layer 360, thereby forming a common electrode pattern 270p and a roof pattern 360p.

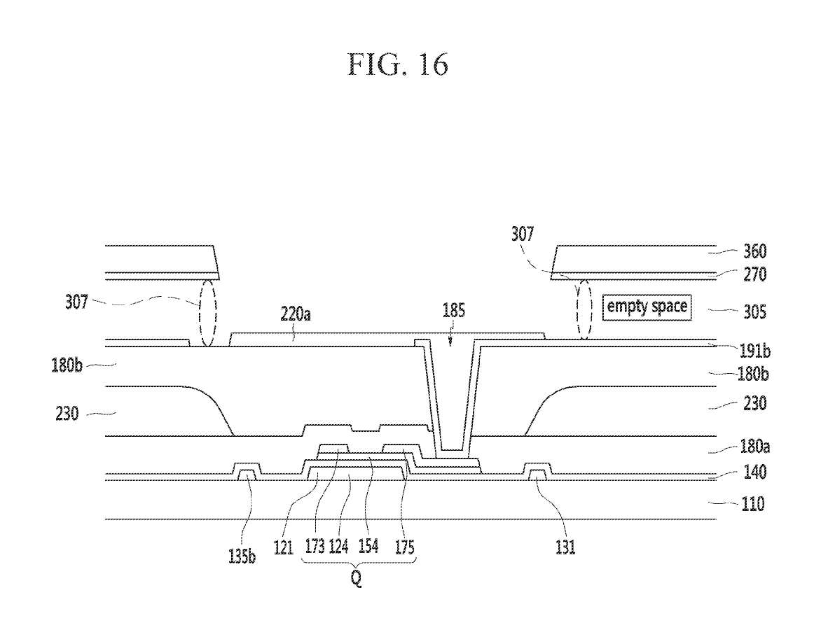

Referring to FIGS. 16 to 18, an O₂ ashing process or a wet etching method is used to remove the sacrificial layer 300 through the liquid crystal injection portion 307FP.

In this case, a plurality of microcavities 305 having inlets 307 are formed.

The microcavity 305 is empty because the sacrificial layer 300 is removed.

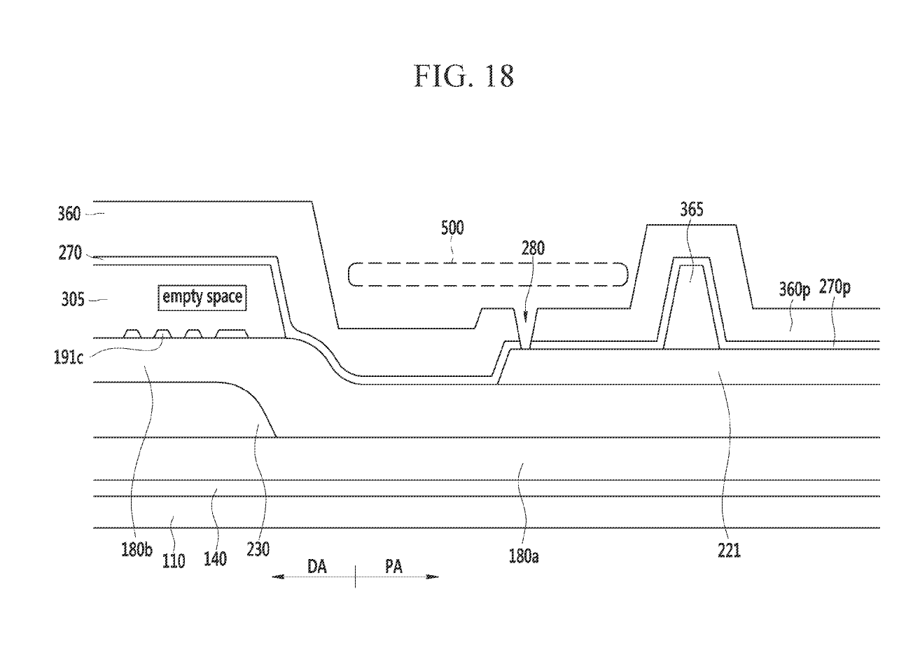

In this case, as shown in FIG. 18, the partition wall 365 formed of the same material as the sacrificial layer 300 is not removed but remains because it is surrounded by the common electrode pattern 270p and the roof pattern 360p.

In this case, an edge portion 500 may be formed between the partition wall 365 and the roof layer 360 of the display area DA.

The edge portion 500 may be elongated along a direction toward which the partition wall 365 extends.

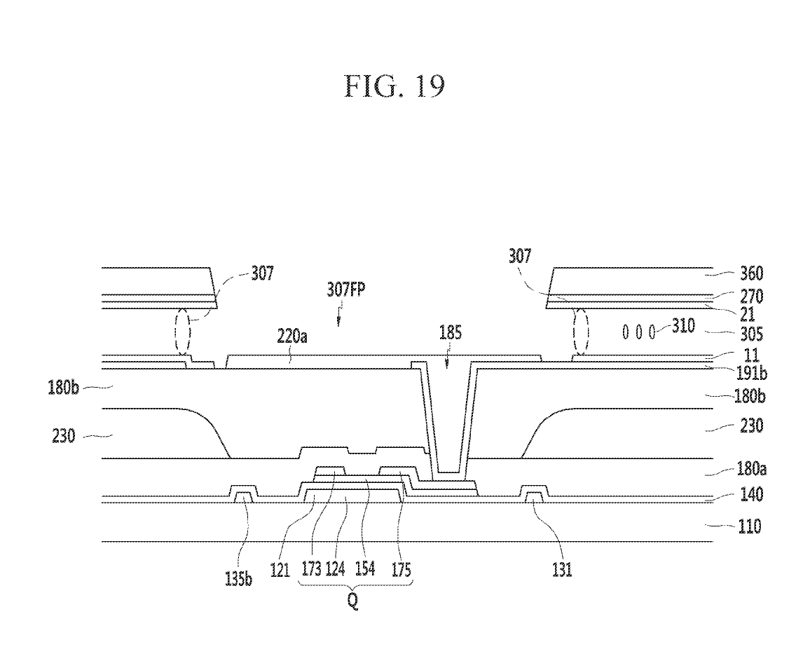

Referring to FIGS. 19 to 21, an aligning material is injected through the inlet 307 to form alignment layers 11 and 21 on the pixel electrode 191 and the common electrode 270.

Specifically, a bake process is performed after injecting the aligning material including solids through the inlet 307.

The aligning agent may be oversupplied such that the aligning agent is uniformly dried in an edge portion of the display area DA through the bake process.

For example, when a capacity for completely filling the plurality of microcavities 305 is 100%, a capacity for oversupplying the alignment agent may be 120% to 300%.

The oversupplied aligning agent may fill even the edge portion 500 of the non-display area (PA), also called the peripheral area PA.

Although not being intentionally oversupplied, the aligning agent may overflow to supply it to the edge portion 500.

The aligning agent filled in the edge portion 500 is blocked by the partition wall 365 from flowing into a pad portion 600.

In addition, since the bake process is performed after the edge portion 500 is sufficiently filled with the aligning agent, the remaining solids after the drying may be uniformly distributed.

Next, a liquid crystal material including liquid crystal molecules 310 is injected into the microcavity 305 through the inlet 307 using an inkjet method or the like.

Subsequently, when a capping layer 390 is formed on the roof layer 360 to cover the inlet 307 and the liquid crystal injection portion 307FP, the LCD as shown in FIG. 2 to FIG. 5 may be formed.

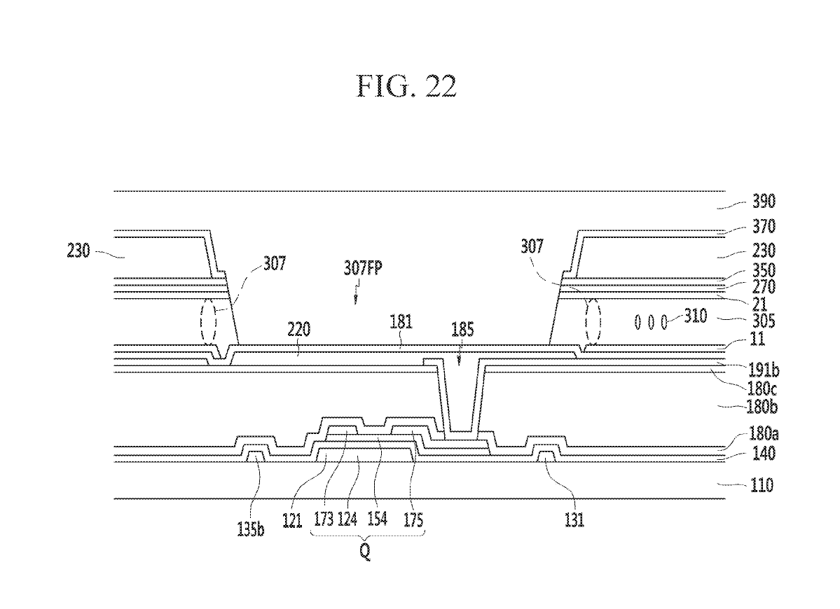

FIGS. 22 to 26 are cross-sectional views of an LCD according to an exemplary embodiment.

A configuration including the thin film transistor Q on the substrate 110 and a configuration including the first and second interlayer insulating layers 180a and 180b are the same as those of the aforementioned exemplary embodiment of FIGS. 3 to 5.

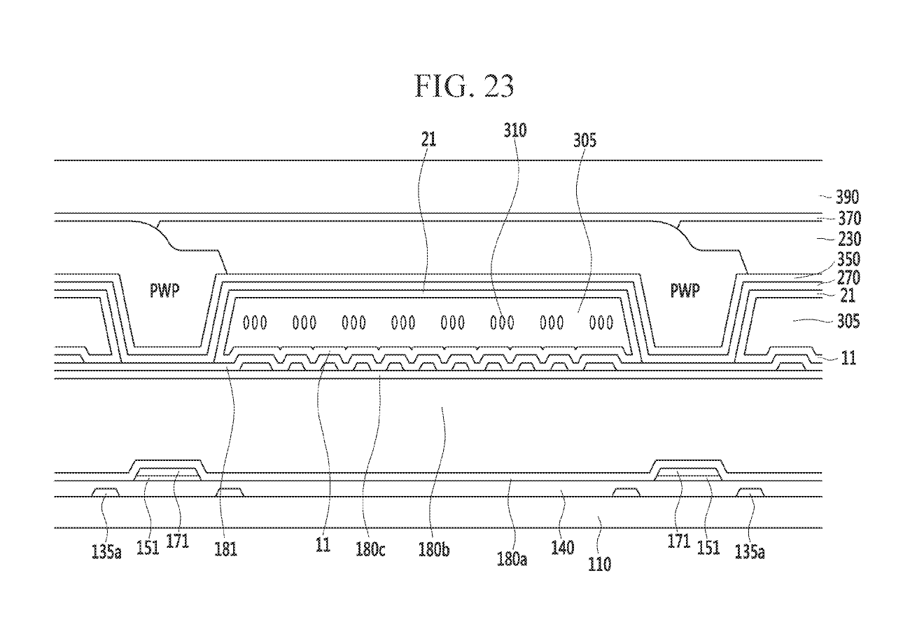

Referring to FIGS. 22 and 23, a third interlayer insulating layer 180c formed of an inorganic material such as a silicon nitride (SiNₓ) or a silicon oxide (SiOₓ) is disposed on the second interlayer insulating layer 180b.

A contact hole 185 may be formed to penetrate the first, second, and third interlayer insulating layers 180a, 180b, and 180c.

A drain electrode 175 and a pixel electrode 191 disposed on the third interlayer insulating layer 180c may be electrically and physically connected to each other through the contact hole 185.

A light blocking member 220 to cover a region where the thin film transistor Q is formed is disposed on the pixel electrode 191. The light blocking member 220 according to the present exemplary embodiment may be formed along a direction that the gate line 121 extends. The light blocking member 220 may be formed of a material that blocks light.

An insulating layer 181 may be formed on the light blocking member 220, and the insulating layer 181 covering the light blocking member 220 may extend on the pixel electrode 191.

A lower alignment layer 11 is formed on the pixel electrode 191, an upper alignment layer 21 is disposed to face the lower alignment layer 11, and a microcavity 305 is formed between the lower and upper alignment layers 11 and 21.

A common electrode 270 and a lower insulating layer 350 are disposed on the upper alignment layer 21.

The lower insulating layer 350 may be formed of a silicon nitride (SiNₓ) or a silicon oxide (SiOₓ).

In the current exemplary embodiment, the common electrode 270 has been described to be formed on the microcavity 305, but in another exemplary embodiment, the common electrode 270 may be formed under the microcavity 305, thereby allowing liquid crystals to be driven according to a coplanar electrode (CE) mode.

In the current exemplary embodiment, a color filter 230 is disposed on the lower insulating layer 350.

As shown in FIG. 23, among the color filters neighboring each other, the color filters 230 with a single color form a partition wall portion (PWP).

The partition wall portion (PWP) is disposed between the microcavities 305 that are adjacent in a horizontal direction.

The partition wall portion (PWP) serves to fill a space between the microcavities 305 that are adjacent to each other in the horizontal direction.

As shown in FIG. 23, the partition wall portion (PWP) is formed to completely fill the space between the microcavities 305, but it is not necessarily limited thereto, and may be modified to partially fill the space.

The partition wall portion (PWP) may be formed along the direction toward which the data line 171 extends.

The color filters 230 adjacent to each other may overlap on the partition wall portion (PWP).

An interface where the adjacent color filters 230 meet each other may be disposed to correspond to the partition wall portion (PWP).

In the current exemplary embodiment, the color filter 230 and the partition wall portion (PWP) serve as a roof layer for supporting the microcavity 305 such that the microcavity 305 can maintain its shape.

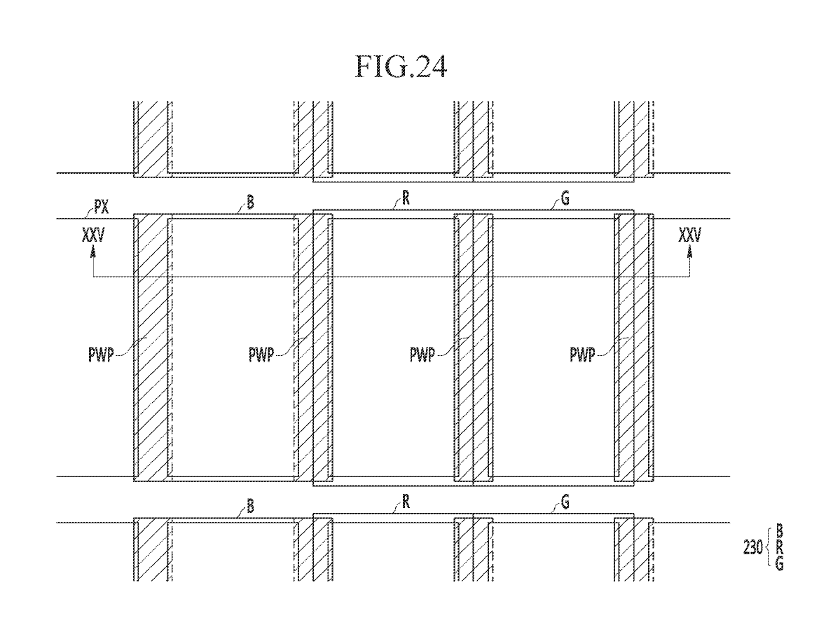

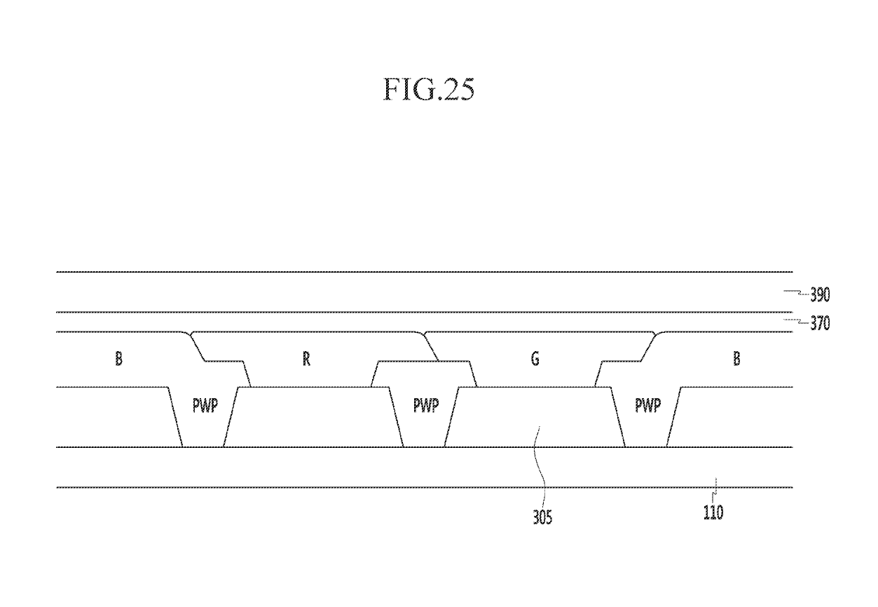

Now, the color filter 230 according to the exemplary embodiment will be described in detail with reference to FIGS. 24 and 25.

FIG. 24 is a top plan view of the color filter and the partition wall portion in the LCD according to the exemplary embodiment.

FIG. 25 is a cross-sectional view of FIG. 24 taken along the line XXV-XXV.

FIGS. 24 and 25 are schematic drawings to make a description based on the color filter and the partition wall portion in the LCD according to the exemplary embodiment, and the details described in FIGS. 22 and 23 may be directly applied to the components between the substrate 110 and the microcavity 305.

Referring to FIGS. 24 and 25, the color filter 230 according to the current exemplary embodiment includes a first color filter, a second color filter, and a third color filter. The first color filter may include a blue color filter (B), the second color filter may include a red color filter (R), and the third color filter may include a green color filter (G).

According to the current exemplary embodiment, the partition wall portion (PWP) is formed by any one of the first, second, and third filters.

In the exemplary embodiment, the first color filter corresponding to the blue color filter (B) form the partition wall portion (PWP).

The blue color filter (B) may include the partition wall portion (PWP) formed to extend from a portion corresponding to the pixel area PX, and the partition wall portion (PWP) disposed between the red color filter (R) and the green color filter (G).

In this case, the red color filter (R) and the green color filter (G) simultaneously cover opposite edge portions of the adjacent partition wall portions (PWPs), and may overlap each other on the partition wall portions (PWPs).

Instead of the blue color filter (B), the red color filter (R) or the green color filter (G) may be used to form the partition wall portion (PWP).

However, since the blue color filter (B) blocks light more effectively than the red color filter (R) or the green color filter (G), reflection due to external light can be reduced if the blue color filter (B) is used to form the partition wall portion (PWP).

In addition, the blue color filter (B) has a favorable taper angle since it is superior in blocking the light and mobility of the photoresist forming the color filter.

Accordingly, when an end of the color filter for forming the partition wall portion (PWP) is undercut or formed to lie down at an angle of more than about 45 degrees with respect to a vertical angle, it may cover a side wall of the partition wall portion (PWP) and allow the color filter coated on the partition wall portion (PWP) to be well-formed.

As shown in FIG. 24, the color filter 230 may be formed to have an island-like shape to correspond to the pixel area PX.

Referring back to FIGS. 22 and 23, an upper insulating layer 370 is disposed on the color filter 230.

The upper insulating layer 370 may be formed of a silicon nitride (SiNₓ) or a silicon oxide (SiOₓ).

A capping layer 390 is disposed on the upper insulating layer 370.

In addition to being disposed in a liquid crystal injection portion 307FP, the capping layer 390 covers the inlet 307 of the microcavity 305 that is exposed by the liquid crystal injection portion 307FP.

The capping layer 390 includes an organic material or an inorganic material.

In this case, the liquid crystal material is illustrated to be removed from the liquid crystal injection portion 307FP, but after being injected into the microcavity 305, the remaining liquid crystal material may exist in the liquid crystal injection portion 307FP.

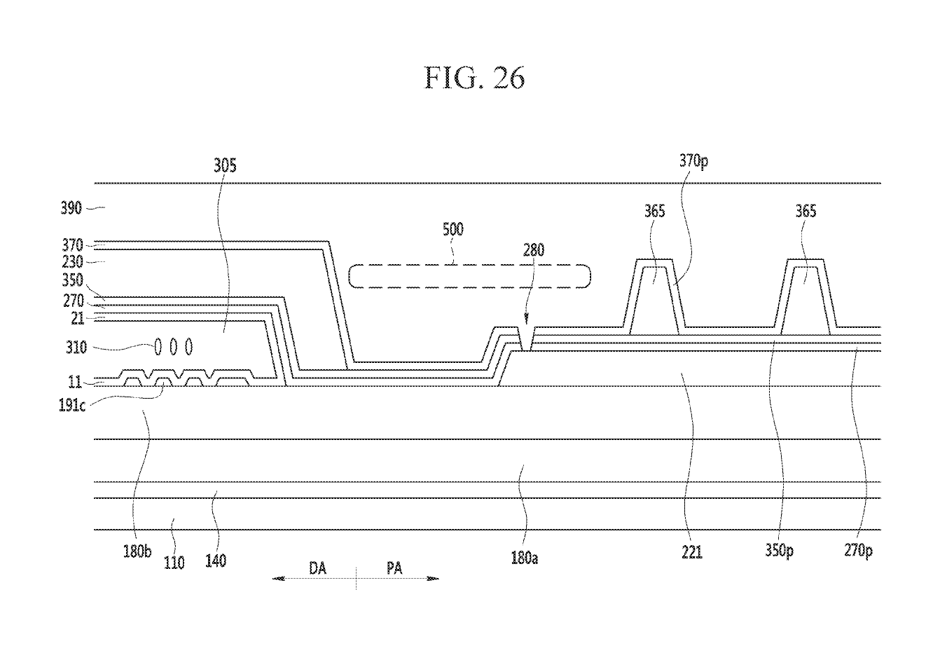

Referring to FIG. 26, a common electrode pattern 270p and a lower insulating pattern 350p are disposed on the light blocking layer 221 of the peripheral area PA.

A partition wall 365 is disposed on the lower insulating pattern 350p.

The partition wall 365 may be formed of the same material as the color filter 230 of the display area DA.

An upper insulating pattern 370p is disposed on the partition wall 365.

In this case, the common electrode 270 and the upper insulating layer 370 of the display area DA are extended to form the common electrode pattern 270p and the upper insulating pattern 370p, respectively.

The upper insulating pattern 370p and the upper insulating layer 370 are formed of the same material and on the same layer, the common electrode pattern 270p and the common electrode 270 are formed of the same material and on the same layer, and the lower insulating pattern 350p and the lower insulating layer 350 may be formed of the same material and on the same layer.

The capping layer 390 may cover the display area DA and the peripheral area PA.

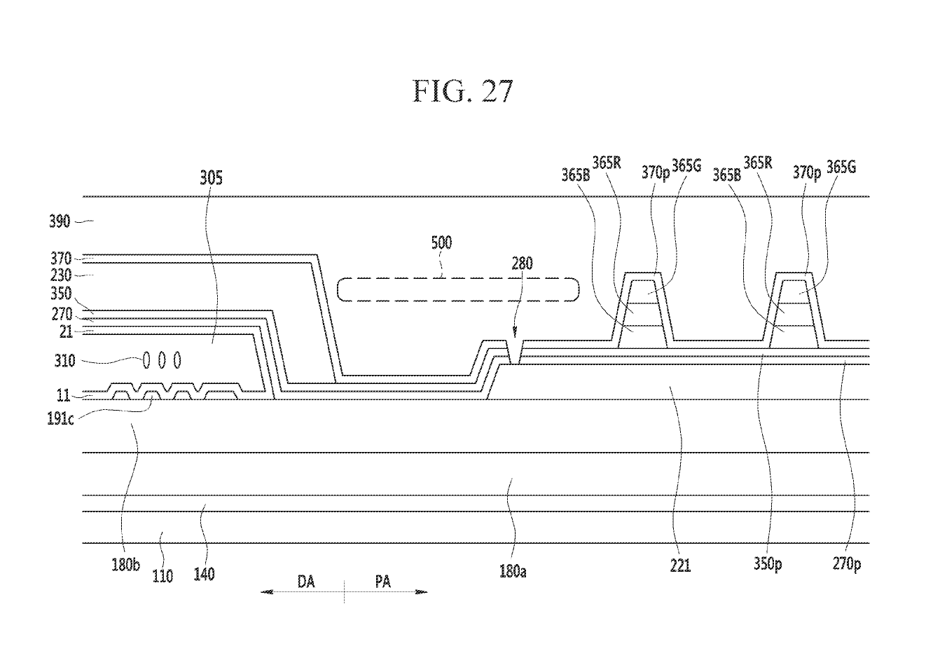

FIG. 27 is a cross-sectional view of an LCD modified from the exemplary embodiment of FIG. 26.

An exemplary embodiment of FIG. 27 is almost the same as the exemplary embodiment described in FIG. 26 except for a structure of the partition wall 365.

Referring to FIG. 27, the partition wall 365 may include a structure in which color filters 365B, 365R, and 365G for displaying different colors are laminated.

In addition to the aforementioned differences, the details described in FIG. 26 may be applied to the current exemplary embodiment.

While the inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

<Description of Symbols>

| | | | |
|---|---|---|---|
| 300 | sacrificial layer | 305 | microcavity |
| 307 | inlet | 360 | roof layer |
| 365 | partition wall | 390 | capping layer |

What is claimed is:

1. A liquid crystal display (LCD) comprising:
a substrate including a display area and a peripheral area;
a thin film transistor disposed on the substrate;
a field generating electrode connected to the thin film transistor;
a partition wall disposed along the peripheral area; a roof layer facing the field generating electrode;
a roof pattern covering the partition wall; and
a liquid crystal layer disposed between the field generating electrode and the roof layer and formed as a plurality of microcavities including liquid crystal molecules,
wherein the roof layer and the roof pattern are formed of at least one inorganic layer.

2. The LCD of claim 1, further comprising a light blocking layer disposed on the substrate,
wherein the light blocking layer is disposed in the peripheral area, and the partition wall is disposed on the light blocking layer.

3. The LCD of claim 2, further comprising a common electrode disposed between the plurality of microcavities and the roof layer, and a common electrode pattern disposed between the partition wall and the roof pattern.

4. The LCD of claim 3, wherein the partition wall is formed of an organic material or a photoresist.

5. The LCD of claim 4, wherein multiple partition walls are formed.

6. The LCD of claim 5, wherein the roof layer and the roof pattern are separated.

7. The LCD of claim 1, wherein the roof layer includes a structure in which first and second inorganic layers having different stresses are laminated.

8. The LCD of claim 7, wherein the first inorganic layer has a compressive stress and the second inorganic layer has a tensile stress.

9. The LCD of claim 8, wherein the first and second inorganic layers are alternately laminated.

10. A manufacturing method of a liquid crystal display (LCD) comprising forming a thin film transistor on a substrate including a display area and a peripheral area; forming a pixel electrode connected to the thin film transistor; forming a sacrificial layer in the display area and the peripheral area; forming a roof layer on the sacrificial layer; forming a plurality of microcavities with inlets by removing the sacrificial layer; and injecting liquid crystal molecules into the plurality of microcavities, wherein the roof layer is formed of at least one inorganic layer, and the sacrificial layer formed in the peripheral area is not removed to thereby form a partition wall.

11. The manufacturing method of claim 10, further comprising forming a roof pattern on the partition wall,
wherein the roof pattern and the roof layer are formed of the same material.

12. The manufacturing method of claim 11, further comprising forming a light blocking layer in the peripheral area,
wherein the light blocking layer is formed to be disposed under the partition wall.

13. The manufacturing method of claim 12, wherein the forming of the roof layer includes forming an inorganic layer on the sacrificial layer and forming a liquid crystal injection portion by patterning the inorganic layer, and the roof layer and the roof pattern are separated in the patterning of the inorganic layer.

14. The manufacturing method of claim 13, further comprising forming a common electrode and a common electrode pattern on the sacrificial layer before the forming of the roof layer,
wherein the common electrode pattern is disposed between the light blocking layer and the roof pattern.

15. The manufacturing method of claim 10, wherein the forming of the roof layer includes sequentially laminating first and second inorganic layers having different stresses.

16. A liquid crystal display (LCD) comprising: a substrate including a display area and a peripheral area; a thin film transistor disposed on the substrate; a field generating electrode connected to the thin film transistor; a roof layer facing the field generating electrode; a partition wall disposed along the peripheral area; and a liquid crystal layer disposed between the field generating electrode and the roof layer and formed as a plurality of microcavities including liquid crystal molecules, wherein the roof layer and the partition wall include a color filter.

17. The LCD of claim 16, further comprising a light blocking layer disposed on the substrate,
wherein the light blocking layer is disposed in the peripheral area, and the partition wall is disposed on the light blocking layer.

18. The LCD of claim 17, further comprising: a lower insulating layer and a common electrode that are disposed between the plurality of microcavities and the roof layer; an upper insulating layer disposed on the roof layer; a lower insulating pattern and a common electrode pattern that are disposed under the partition wall; and an upper insulating pattern disposed on the partition wall.

19. The LCD of claim 18, wherein multiple partition walls are formed.

20. The LCD of claim 19, wherein the roof layer and the partition wall are separated.
